(19) United States
(12) Patent Application Publication
(10) Pub. No.: US 2002/0166125 A1
(43) Pub. Date: Nov. 7, 2002

(54) Universal home cabling system

(76) Inventor: Daniel E. Fulmer II, Jacksonville Beach, FL (US)

Correspondence Address: Thomas C. Saitta, Suite 1500, 1301 Riverplace Blvd., Jacksonville, FL, 32207, US

(21) Appl. No.: 10/091,886

(22) Filed: Mar. 5, 2002

Related U.S. Application Data
(60) Provisional application No. 60/273,460, filed on Mar. 5, 2001.

(51) Int. Cl. H04N 7/18

(52) U.S. Cl. 725/78; 725/74

(57) ABSTRACT

A universal cabling or prewiring system installed in a home or other building during construction, the system providing electronic communication between a multitude of electronic devices and electronic control devices, where the system can accommodate changes in location or type of equipment, can receive additional equipment not originally contemplated, can receive equipment not yet developed, such that any home design can be prewired in a generally standardized format.

This application claims the benefit of U.S. Provisional Patent Application Serial No. 60/273,460, filed Mar. 5, 2001.

### BACKGROUND OF THE INVENTION

This invention relates generally to the field of cabling systems for homes or other buildings, where the cabling systems are structured to provide electronic communication between various home automation and electronic devices. It relates more particularly to pre-wired infrastructure systems which connect to, control and provide electronic communication from various devices in a home, such as telecommunication devices, computer networks, TV and audio distribution, speakers, infra-red controls, and home control components. These may also include lights, appliances, HVAC, security, drapes/blinds, fans, audio-video equipment, cameras, CCTV, phones, intercoms, computer networks, door locks, irrigation, plumbing, driveway sensors, pool/spa equipment, weather stations, pet control, etc.

The number of household electronic devices developed for consumer use and for operation of systems which were previously manually actuated has increased dramatically in recent years. New developments in microprocessor equipment and “self-intelligent or smart” appliances have made it possible to provide a home owner with unprecedented opportunities in convenience. The concept of pre-wiring a home during construction for basic electronic communication has grown from simply providing separate wiring or cabling to bring in telephone and cable TV, as well as mounting audio speakers in different rooms all communicating with a single stereo, to the current status where practically any functioning equipment in a home can be controlled from remote locations and where electronic communication between equipment in separate rooms provides multi-directional control and output.

It is now known to pre-wire a home during construction to provide control and/or output jacks in multiple rooms, such as for placement of telephones, computers, cable TV, speakers, etc. The currently known systems, however, suffer a major drawback in that they are engineered either in customized format in response to specific choices as to what equipment will be utilized at what location in a house, or they are engineered in preset package form attempting to cover the most common situations likely to be encountered. Both these systems cannot adapt to change, whether the change comes about from decisions to utilize different equipment in unforeseen locations, from new equipment being added after the home is fully constructed, or from new technology which did not even exist at the time of construction. Such changes require the home to be rewired or retrofitted.

As little as five years ago, there were little or no sources for structured cabling. Early types of structured cabling only supported video, phone, and networking. Even the emerging, more “advanced” packages only include additional cabling for audio. The current systems do not begin to address the issues of home automation, just standard distribution of existing signals in the home.

It is an object of this invention, therefore, to provide a universal cabling or pre-wire system which is not vulnerable to the problems encountered by the known systems, in that the invention provides a cabling system which can be adapted to a multitude of changes without the need to rewire, which can accommodate new technological developments without the need to rewire, which provides control and usage options for various types of electronic equipment not available under the known systems.

### SUMMARY OF THE INVENTION

The invention is a universal cabling or pre-wiring system which is installed in a home or other building during construction of the home, the system providing electronic communication between a multitude of electronic devices and electronic control devices, where the system can accommodate changes in location or type of equipment, can receive additional equipment not originally contemplated, can receive equipment not yet developed, such that any home design can be pre-wired in a generally standardized format. The system utilizes known wire and cable with optimum ratings, specifically CAT5 (unshielded twisted pair wiring rated at 100-150megahertz and 100 megabits/sec), CAT5E (shielded twisted pair wiring rated at 350 megahertz and 150 megabits/sec), RG6 Quad Shield (coaxial cable), 16/4 (audio wire) and 16/2 (audio wire), provided in a unique combination and arrangement which maximizes functionality. The system incorporates a main distribution and control center and a home theater distribution and control center, in communication with each other and the various multimedia room outlets. Multimedia outlets in a given room are provided in specific communication patterns such that the functionality is increased.

### DETAILED DESCRIPTION OF THE INVENTION

The invention will now be described in detail as to the system and the methodology. It is to be understood that the specific grades or designations of various cables is a reference to the state of the art at this time, such that substitutions of equivalent or upgraded cables having differing or higher designations is contemplated within the invention, such that the system will always maintain the maximum capability for communication with upgraded and improved devices, appliances, electronic components, etc. It is also to be understood that, while the system is described as related to a home, the system and methodology are applicable to commercial and industrial buildings.

This system offers the versatility to pre-wire the home during construction in a universal system which is capable of handling multiple electronic components, such that the home owner has the ability to upgrade, add, and expand to different products from many manufacturers, using a multitude of standards and protocols to control and use a variety of existing and emerging technologies, appliances and products, at any time after construction without the need to re-wire or limit choices related to new electronic devices. This frees the owner during the building of the home from the worry of finding, learning about, and understanding or knowing any and everything the owner my want in future. Once the universal cabling infra-structure is in place, they can then learn about and determine what they want to add to the system.

A homeowner utilizing the invention can at any time add an analog or digital phone system, which can distribute up to 8 incoming phone lines to up to 24 rooms, also allowing the homeowner to answer and unlock the door from any phone in the home including wireless 900 MHz or 2.4 GHz phones. At the same or later time, they can add X10 lighting control by SmartLinc, Leviton or X10Pro, and a Crestron, Panja, JDS Timecommander or many other control systems. This allows them to control lights from remotes, the phones, touchscreens, wallpads, the internet and more.

The system can accept products using all standard analog and digital video and audio signals, can utilize products that use RS232, RS485, ASCII, Digital IO, analog IO, contact closure, infra-red, IEEE1394, 802.11b, radio frequency, X10, powerline carrier, the point being, the client doesn't need to even know what they want or they want the house to do, we designed the UCS to take care of that. The system also includes surge protection at the head end, rated in the high nano to Pico second clamping rate, for video, electrical, and telecom.

### Definitions Used Herein

Pre-wire: installation of wiring during construction of the home.

Central Distribution Point: a relatively centrally located space in the home from which the cabling infrastructure is initiated, preferably climate controlled, i.e., within the air-conditioned portion of the home, and not near electrical sub-panels or high voltage devices or wires.

Run: a length of cable from one point to another.

Structured Cabling: a cabling method wherein all cable runs extend to a single point of distribution, and wherein wall plates support multiple functions.

Home Run: a cable run from a single central point terminating in the room or location for which it is intended for use.

Loop or Looping: a method fo wiring also known as daisy chaining, where cable is connected from one point to the next, and so forth, in a series.

Trim-Out: the connection of cables to trim or wall plates, or inserts installed into a multi-port trim plate.

Punch-Down: a generic term used to describe the process of connecting wires or cables to punch blocks, central distribution hubs or bus-bars.

Sub-systems: various electrical and electronic systems in the home, such as lighting, HVAC, pools, security systems, appliances, drapes and blinds, home theaters, distributed audio, home networks, etc.

### General Methodology

The system utilizes the following cable/wires: CAT5 (24g/8c), rated from 100-150 MHz or better; CAT5e (24g/4c), rated to 350 MHz or better; RG6 Quad Shield, rated to 2.4 GHZ or better; 16/4 high strand or better; 16/2 high strand or better; 18/4/5 (shielded).

Two main distribution areas are created: a central distribution point for generally non-interactive components, and an equipment room or location point, also referred to as a multimedia or home theater distribution point, for generally interactive components. These areas are preferably separate, as the equipment utilized at each area differs. Most distribution panels and equipment are designed to be mounted vertically on a wall, and is usually combined with a panel enclosure. Audio, video and control equipment is usually designed to rest on shelves, rack mount or set on a table top, and typically produce a significant amount of heat so as to require climate control and larger space for heat dispersal. The equipment room or location concept provides for frequent and easy access to the audio/video equipment, whereas access and aesthetics are not important for the distribution equipment which controls the data, communications and automation functions, i.e, the non-interactive components.

Most wires home run to the central distribution point, where a distribution panel is used to punch down and connect cabling to various services. A variety of panels from different manufacturers can be used. Distribution centers must be located in air conditioned space, as centrally located as possible, preferably in a dedicated closet or small room.

The paths should be plotted to result in the least electrical intermingling, least drilling, shortest runs, easiest runs, and fewest number of studs in between runs. Holes through studs should be separately drilled—the electrical holes should not be used to avoid parallel running with electrical wiring. Stay at least 1-4 ft from electrical cabling and only cross at 90 degrees. If running with electrical is absolutely necessary, use aluminum foil to shield wires (for short distances only). Staple cables to studs every 3-4′, and staple in center of stud. This prevents cable from moving during construction and getting nailed through during/after. Keep cables in attic spaces above walking area “no-step” process, staple to rafters. This prevents stepping on in attic, future snags, and problems, looks cleaner.

Always measure existing electrical boxes to compare box height, be consistent room to room. Measure from lower screw holes to floor (center to center), in each room and wall. Always make sure boxes are installed level and plumb. Only use plastic single gang boxes, or nothing for VC locations. During pre-wire, leave 1-2′ of cable hanging out at boxes, and 4-6′ at head end, 3-4′ at speakers-zig zag in ceiling. Always bag and tape all cables, with top of bag in wall behind box, and back straight and narrow, taped at top and bottom-inside and outside-for protection. Label outside wires and place cable labels around cables at J-box friction location.

### Wire and Cable Management

Use color coding for wiring, with the following combinations suggested. All wiring is from the main distribution panel unless otherwise noted.

| | |
|---|---|
| RG6 (video feeds) | Black - out and satellite |
| | White - in and satellite |
| | Yellow - cameras, link, sub, satellite |
| CAT5 (telecom/control) | Blue - phone |
| | Green - theater link/connect wires between control systems |
| | White - HVAC, garage door, gate and various control wire |
| | Red - audio/video control wiring (IR, Elan, volume, etc.) |
| CAT5E (PC network/HSD) | Yellow - data networking |
| 18/4/5 (interface) | Gray - touchscreens, camera power, line level audio |
| 16/4 (speakers/feeds) | Green - to volume control, J-box in rooms (from home |
| | theater) |
| | Blue - loop out |
| | White - loop in (TVA20 from volume control to TV-LOC) |
| 16/2 (speakers/local) | Blue/White - for left and right speaker channels |

At cable origin, either central distribution point or equipment location, wrap all cables from each room together with electrical tape and label entire bundle with room name.

### General Cabling Technique

Position interface locations (keypads, touch screens, etc.) (2 CAT5 each) at:

inside front door foyer area

inside garage door entry area

back patio door location

add as needed at other egress and convenience points

2 each CAT5 to security panel location—from distribution panel for communication and control.

1 each CAT5 to each air handler/HVAC control panel location—from distribution panel.

1 each CAT5 to each electrical panel and sub-panel (run to 4 ⅛×4 ⅛ box with romex between box and panel—potentially connected to a dedicated 15A breaker.

4 each CAT5E, 1 each CAT5 home run from home theater location.

1 each CAT5E home run from central, small PC LAN server.

1 each CAT5E home run from any non-local LAN hub.

1 door intercom wire—CAT5—to all main exterior doors.

1 each CAT5, 1 each 18/4s HT to front door jam for future magnetic lock control

2 each+DoorCams—RG6Q, 22/4, and CAT5—determine location, front and rear.

### Video, Power and Control Feeds

6 each RG6 stubbed out on southwest end of home with both best angle for reception, ease of access, and somewhat hidden from view, for HDSAT, DSS, HDTV, antennae—stubbed out alone.

You must determine the prescribed satellite angles and azimuths for your area.

1 each RG6 for cable TV—mark with plastic or some long lasting label.

2 each CAT5 for TELCO—allows up to 8 lines to any room.

1 ft to side of cable TV wire—both away from SAT wires. Can add additional CAT5 to TELCO location for dedicated DSL or other HSD access direct from demarcation point.

3 each CAT5 for future—gang together with next. use for photovoltaic cells, anemometers, weather stations, temp sensors, gate intercoms.

1-2 each COAX, 1 each 18/4s, 1 each CAT5 for future use—i.e. gatecam, control, etc.

1-2 each 16/4 near rear of house for external speakers.

2 each CAT5, 1 each 18/4 shielded home run from any pool pump or interface.

2 each CAT5, 1 each 18/4 shielded stubbed out for future solar control systems.

Calls for wall phone in master bath—each CAT5 home run

Calls for TV in niche location or counter top location, master bath, main baths—1each RG6 home run.

### Room Specific Wiring

All Master bedrooms get 2-16/4 and 1-CAT5 loop from keypad/volume control location to TV location.

1 RG6 Q loop for one 72″ wall mount TV location—intersect of two walls, high comer

All I-rooms (i.e., rooms capable of serving multiple purposes, such as a bedroom, office, den, etc.) get:

1-16/4 home run to volume control location

1-CAT5 home run to volume control location

2 16/2 to local speakers—locate squarely in ceiling in center of room

1 CAT5 home run phone location—near bedside outlet

1 CAT5E home run phone location

2 RG6Q home run to TV location—across from bed

1 CAT5 loop from phone location to TV

1 CAT5 home run to TV

Volume control/keypad/touchscreen locations are best near room or main entry doors at 45″ from the floor, and/or 8-12″ directly above the rooms light switches. Unless speakers are installed at time of construction, speaker cables with 4 to 5 feet extra length are rolled up, taped and fastened to overhanging stud, dropped directly over future speaker cut-out. Speaker wires centered to the ceiling fans or lights, oriented left and right of the beds, and covered with drywall. In master bed, or other locations where surround sound or better is desired, speakers or wires are located above bed, towards the head. A small local surround system with small front center, left and right speakers give you surround sound, with rear speakers being in ceiling.

All Media/Home Theater/Equipment Rooms get

All 16/4 home runs behind media gear

All CAT5 home runs behind media gear

2 16/2 to local speakers—locate at rear of room, in ceiling LTBD

2 16/2 to left and right of media center (zigzag down between studs, in wall) LTBD

1 16/2 for center channel—(zigzag down between studs- wall center)

4 RG6Q home run to TV location—

1 CAT5 loop from phone location

4 CAT5 home run

2 CAT5E network home run to control system connectivity, MP3 recorders/servers, video-ono-demand storage and distribution

16/4 loops to any other smaller theater rooms, cross-connecting different audio source locations

1 CAT5 home run to phone location

1 CAT5e home run to phone location

All Kitchens get

1 16/4 to home theater from volume control location

2 16/2 from volume control to ceiling or preferred speaker locations

1 CAT5E from home theater to volume control location

1 CAT5 home run from wall phone

1 CAT5 loop from wall location to counter phone (optional)

1 CAT5E home run from counter, desk niche, or in-drawer location

2 RG6Q to counter or TV niche location

optional Appliance Cabling Package—6 CAT5 home runs to refrigerator, oven, washer/dryer, microwave, dishwasher, etc., plus single CAT5 home run to distribution center.

Lanias and patios get 1 phone/TV outlet—and 2 speakers (ceiling or surface mount). Laundry rooms are wired for audio, phone, network and video. Also see appliance package.

### Trim-out Technique

Punch down involves all cables terminating in distribution panel. If not being used, it will be terminated into the appropriate patch block, which can simply be patched through to the necessary service or services.

Volume control/keypad/touchscreen locations, if unused, are to be covered by a standard single gang, blank wall plate.

Bedrooms are trimmed using Multi-port outlets in the following configuration:

At bed location—a single gang multi-port trim plate with:

1 phone jack (RJ11 or 6 cond.)—wired using blue and orange pairs of CAT5, to 2 line POTS standard.

1 fax/pc jack (RJ1 or 6 cond.)—wired using green and brown pairs of CAT5, to 2 line POTS standard.

1 home LAN jack, CAT5 rated (wired to 568B standards)

(master bedroom(s) get duplicate phone jacks on either side of bed).

At TV location—a single gang multi-port trim plate with;

1phone jack—wired using blue and orange pairs of CAT5, for POTS standard, looped back to g &

b at bed location

1LAN Jack—(wired to 568B standards)

2 coaxial connections

1 unused—untrimmed CAT5 left behind plate for future use (such as Crestnet, IEE1394b, IR, etc.)

All Media Rooms are trimmed using bulkhead fittings that multiple cables feed through, or custom fitted ported outlets, for bulk audio distribution cabling. Location is usually behind audio/video equipment. Cables are trimmed accordingly. Speakers are trimmed as needed, and can be installed at a later date.

Additionally, the cabling for audio speakers, volume controls and keypad/touchscreen interfaces is run to the media center equipment location. This is for ease of adding and integrating different processors to control anything from audio/video distribution to lighting, HVAC, appliance control and more.

This system allows for maximum upgradability, scalability, and expandability with the least amount of change at each individual rooms trim plate locations. All of the changes, upgrades, etc., are made at the distribution center. There is no need to change the wiring at each rooms phone jack to add any type of phone system. TV and fax locations have utilized the g & b pairs of wires, so they can bypass phone systems and intercom systems, when added, without changing room wiring. This is due to the fact that most satellite and digital cable TV providers require a phone line to their TV converter boxes, and these cannot work with or through a phone, KSU or PBX type system. Adding a phone system without this trim configuration would result in the converters not working, and having to rewire at each TV location with a tuner/receiver that requires a direct phone connection (i.e., for interactive movie ordering, digital cable receiver or DSS receivers).

Multiple cameras can be added and viewed from any TV location in the house, by flipping to a pre-designated channel or channels. Again, without changing any trim or cabling in the individual rooms.

The coaxial ports in each room can serve multiple functions. Since there are dual outlets, video can be fed into the room via one port, and a camera or DVD from that room can be utilized by any room in the home. Additionally this can be used to provide HSD access or DSS access to the room. The key is not the coaxial, but the extra CAT5 and network connection we use, for future control and integration of that equipment, not just distributing it's signal.

At volume control locations, the homeowner has the option to choose to install and upgrade from or to standard single gang volume controls, single gang audio control keypads, double gang keypad systems, touchpads, high end touchscreens and more.

The system is compatible and upgradable with control electronic brands such as HomeDirector, ActiveHome, JDS Timecommnader/Plus, JDS Stargate, HomeBase Pro, HouseLinc, HomeVision, HAL 2000, Crestron, ELAN and others, with device controllers and subsystems such as X10, Leviton, Lutron, SwitchLinc, Panasonic, DSC, Ademco, napco, LinkSys, Channel Plus, Niles, ELAN, Kustom, Russound and others, new and emerging technologies such as IEEE 1394/Firewire, Sony Ilinc, Crestnet, MPS distribution, HD satellite ready, ADSL/HSD networking, e-appliances and others.

Where a standard multimedia outlet in a known system (prior art) usually will have an in port and an out port for cable, a port for computer networking and a port for telephone, the invention will provide a pair of multimedia outlets in a single room, where the telephone port is connected as a looped bypass, the second outlet having a telephone port and a main in port. This enables the system to provide a much improved video, telephone and computer network which is highly adaptable.

I claim:

1. An universal home cabling system for multiple rooms comprising a central distribution point housing non-interactive components and a multimedia distribution point housing interactive controls, cabling connecting said multimedia distribution point to said central distribution point, cabling connecting said central distribution point to multiple rooms, and cabling connecting said multimedia distribution point to multiple rooms, whereby various electronic devices can be located in any of said multiple rooms and connected to said cabling from either said central distribution point, said multimedia distribution point or both, and whereby said various electronic devices can be controlled from within each said multiple rooms or from said multimedia distribution point.

2. The system of claim 1, wherein all of said multiple rooms are provided with equivalent cabling, such that each of said multiple rooms may serve multiple function within said home.

3. The system of claim 1, wherein each of said multiple rooms is provided with at least one multimedia outlet, at least one technical outlet and at least one volume control/touchscreen outlet.

4. The system of claim 3, wherein said multimedia distribution point comprises:
two 16/2 cables connected to a pair of local speaker location,
two 16/2 cables connected to a left and right channel of media center location,
one 16/2 cable connected to a center channel location,
four RG6Q cables home run to a TV location,
one CAT5 cable loop from a phone location,
four CAT5 home run from central distribution point,
two CAT5E cables home run to a control system connectivity, MP3 recorders/servers, video-ono-demand storage and distribution location,
one CAT5 cable home run to a phone location,
one CAT5E cable home run to a phone location.

5. The system of claim 3, wherein each of said multiple rooms comprises:
one 16/4 cable home run to a volume control location,
one CAT5 cable home run to a volume control location,
two 16/2 cables connected to a pair of local speaker locations,
one CAT5 cable home run to a phone location,
one CAT5E cable home run to a phone location,
two RG6Q cables home run to a TV location,
one CAT5 cable loop from a phone location to a TV location, and
one CAT5 cable home run to a TV location.

6. The system of claim 4, wherein each of said multiple rooms comprises:
one 16/4 cable home run to a volume control location,
one CAT5 cable home run to a volume control location,
two 16/2 cables connected to a pair of local speaker locations,
one CAT5 cable home run to a phone location,
one CAT5E cable home run to a phone location,
two RG6Q cables home run to a TV location,
one CAT5 cable loop from a phone location to a TV location, and
one CAT5 cable home run to a TV location.

7. The system of claim 1, further comprising:
position interface locations located at an inside front door foyer area, an inside garage door entry area, and a back patio door location,
two CAT5 cables connected to a security panel location from said central distribution panel for communication and control,
one CAT5 cable connected to an air handler/HVAC control panel location from said central distribution panel,
one CAT5 cable to an electrical panel and sub-panel location,
four CAT5E cables and one CAT5 cable home run from a home theater location,
one RG6 cable for cable TV application, and
two CAT5 cables for telecommunication applications.

8. The system of claim 4, further comprising:
position interface locations located at an inside front door foyer area, an inside garage door entry area, and a back patio door location,
two CAT5 cables connected to a security panel location from said central distribution panel for communication and control,
one CAT5 cable connected to an air handler/HVAC control panel location from said central distribution panel,
one CAT5 cable to an electrical panel and sub-panel location,
four CAT5E cables and one CAT5 cable home run from a home theater location,
one RG6 cable for cable TV application, and
two CAT5 cables for telecommunication applications.

9. The system of claim 5, further comprising:
position interface locations located at an inside front door foyer area, an inside garage door entry area, and a back patio door location,
two CAT5 cables connected to a security panel location from said central distribution panel for communication and control,
one CAT5 cable connected to an air handler/HVAC control panel location from said central distribution panel,
one CAT5 cable to an electrical panel and sub-panel location,
four CAT5E cables and one CAT5 cable home run from a home theater location,
one RG6 cable for cable TV application, and
two CAT5 cables for telecommunication applications.

10. The system of claim 6, further comprising:
position interface locations located at an inside front door foyer area, an inside garage door entry area, and a back patio door location,
two CAT5 cables connected to a security panel location from said central distribution panel for communication and control,
one CAT5 cable connected to an air handler/HVAC control panel location from said central distribution panel,
one CAT5 cable to an electrical panel and sub-panel location,
four CAT5E cables and one CAT5 cable home run from a home theater location,
one RG6 cable for cable TV application, and
two CAT5 cables for telecommunication applications.

11. An universal home cabling system for multiple rooms comprising a central distribution point housing non-interactive components and a multimedia distribution point housing interactive controls, cabling connecting said multimedia distribution point to said central distribution point, cabling connecting said central distribution point to multiple rooms, and cabling connecting said multimedia distribution point to multiple rooms, whereby various electronic devices can be located in any of said multiple rooms and connected to said cabling from either said central distribution point, said multimedia distribution point or both, whereby said various electronic devices can be controlled from within each said multiple rooms or from said multimedia distribution point, and whereby said system is capable of functioning with upgraded electronic devices without replacing said cabling.
